(19) United States
(12) Patent Application Publication
(10) Pub. No.: US 2026/0058290 A1
(43) Pub. Date: Feb. 26, 2026

(54) BATTERY ASSEMBLY

(71) Applicant: Prime Planet Energy & Solutions, Inc., Tokyo (JP)

(72) Inventor: Shunsuke YASUI, Osaka (JP)

(21) Appl. No.: 19/271,788

(22) Filed: Jul. 17, 2025

(30) Foreign Application Priority Data
Aug. 20, 2024 (JP) 2024-138900

(51) Int. Cl. H01M 50/293; H01M 10/647; H01M 10/653; H01M 10/658; H01M 50/209; H01M 50/242; H01M 50/291; H01M 50/588

(52) U.S. Cl. CPC H01M 50/293; H01M 10/647; H01M 10/653; H01M 10/658; H01M 50/209; H01M 50/242; H01M 50/291; H01M 50/588

(57) ABSTRACT

A separator includes: a first layer having a melting point of 950° C. or more and 2715° C. or less; a second layer having a heat conductivity of 0.02 W/m·K or more and 0.15 W/m·K or less under an environment of a temperature of 700° C. and a pressure of 0.2 MPa; and a third layer for which a compressive load acting on a test piece having a rectangular shape and a dimension of 50 mm square when viewed in a first direction is 0.7 kN or more when a thickness of the test piece is 5 mm and is 8 kN or less when the thickness of the test piece is 2.5 mm, and the first layer, the second layer, and the third layer are provided side by side in the first direction.

### CROSS REFERENCE TO RELATED APPLICATIONS

This nonprovisional application is based on Japanese Patent Application No. 2024-138900 filed on Aug. 20, 2024 with the Japan Patent Office, the entire contents of which are hereby incorporated by reference.

### BACKGROUND OF THE INVENTION

### Field of the Invention

The present technology relates to a battery assembly.

### Description of the Background Art

In a battery assembly in which a plurality of batteries are stacked, it is a conventional practice to interpose, between adjacent batteries, a member having a function of suppressing heat transfer or cushioning a surface pressure.

Examples of conventional devices include those described in Japanese Patent Laying-Open No. 2020-165483 and Japanese Patent Laying-Open No. 2007-165698.

### SUMMARY OF THE INVENTION

In a battery assembly, it is required to ensure heat insulation between adjacent batteries. Moreover, when thermal runaway occurs in a battery of the battery assembly, an unintended influence on an adjacent battery is also required to be suppressed. From a viewpoint different from the above, it is also required to reduce the size of the battery assembly.

From the viewpoint of satisfying these requirements, there is still room for improvement in the conventional battery assembly.

An object of the present technology is to provide a battery assembly in which heat insulation between adjacent batteries, suppression of an unintended influence on an adjacent battery during thermal runaway, and size reduction of the battery assembly as a whole are achieved.

The present technology provides the following battery assembly.
[1] A battery assembly comprising: a plurality of batteries arranged in a first direction; and a separator provided between the plurality of batteries, wherein the separator includes a first layer having a melting point of 950° C. or more and 2715° C. or less, a second layer having a heat conductivity of 0.02 W/m·K or more and 0.15 W/m· K or less under an environment of a temperature of 700° C. and a pressure of 0.2 MPa, and a third layer for which a compressive load acting on a test piece having a rectangular shape and a dimension of 50 mm square when viewed in the first direction is 0.7 kN or more when a thickness of the test piece is 5 mm and is 8 kN or less when the thickness of the test piece is 2.5 mm, and the first layer, the second layer, and the third layer are provided side by side in the first direction.
[2] The battery assembly according to [1], wherein the first layer includes a portion having a waveform shape or a curved shape.
[3] The battery assembly according to [1] or [2], wherein the first layer is disposed to be sandwiched between the second layer and the third layer in the first direction.
[4] A battery assembly comprising: a plurality of batteries arranged in a first direction; and a separator provided between the plurality of batteries, wherein the separator includes a first layer having a melting point of 950° C. or more and 2000° C. or less, and a second layer having a heat conductivity of 0.02 W/m·K or more and 0.15 W/m·K or less under an environment of a temperature of 700° C. and a pressure of 0.2 MPa, the first layer includes a portion having a waveform shape or a curved shape, and the first layer and the second layer are provided side by side in the first direction.
[5] The battery assembly according to any one of [1] to [4], wherein the first layer is composed of a metal, a ceramic, or glass.
[6] The battery assembly according to any one of [1] to [5], wherein the first layer has a thickness of 0.3 mm or more and 2.0 mm or less.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a battery assembly.

FIG. 2 is a perspective view showing a battery.

FIG. 3 is a first cross sectional view of a separator.

FIG. 4 is a second cross sectional view of the separator.

FIG. 5 is a third cross sectional view of the separator.

FIG. 6 is a fourth cross sectional view of the separator.

FIG. 7 is a fifth cross sectional view of the separator.

FIG. 8 is a sixth cross sectional view of the separator.

FIG. 9 is a seventh cross sectional view of the separator.

FIG. 10 is an eighth cross sectional view of the separator.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “battery” is not limited to a lithium ion battery, and may include other batteries such as a nickel-metal hydride battery and a sodium-ion battery. In the present specification, the term “electrode” may collectively represent a positive electrode and a negative electrode.

In the present specification, the “battery cell” can be mounted on vehicles such as a hybrid electric vehicle (HEV), a plug-in hybrid electric vehicle (PHEV), and a battery electric vehicle (BEV). It should be noted that the use of the “battery” is not limited to the use in a vehicle.

FIG. 1 is a perspective view showing a battery assembly. As shown in FIG. 1, battery assembly 1 includes batteries 100, separators 200, and end plates 300. Batteries 100 and separators 200 are arranged alternately along a Y axis direction (first direction). End plates 300 are provided at both ends in the Y axis direction.

The plurality of batteries 100 are batteries each having a prismatic shape, and are provided along a Y axis direction. The plurality of batteries 100 are electrically connected together by a bus bar (not shown).

Separators 200 are provided between the plurality of batteries 100. Each of separators 200 is an insulating member that prevents unintended electrical conduction between adjacent batteries 100. Separator 200 secures an electrical insulation property between adjacent batteries 100. Separator 200 can also be provided between battery 100 and end plate 300.

End plates 300 provided at both ends in the Y axis direction are connected to each other by a restraint member (not shown). On this occasion, the stack of the plurality of batteries 100 and separators 200 is held with the stack being compressed in the Y axis direction by end plates 300. As a reaction, a reaction force from battery 100 acts on each end plate 300, with the result that a tensile stress in the Y axis direction is generated in the restraint member.

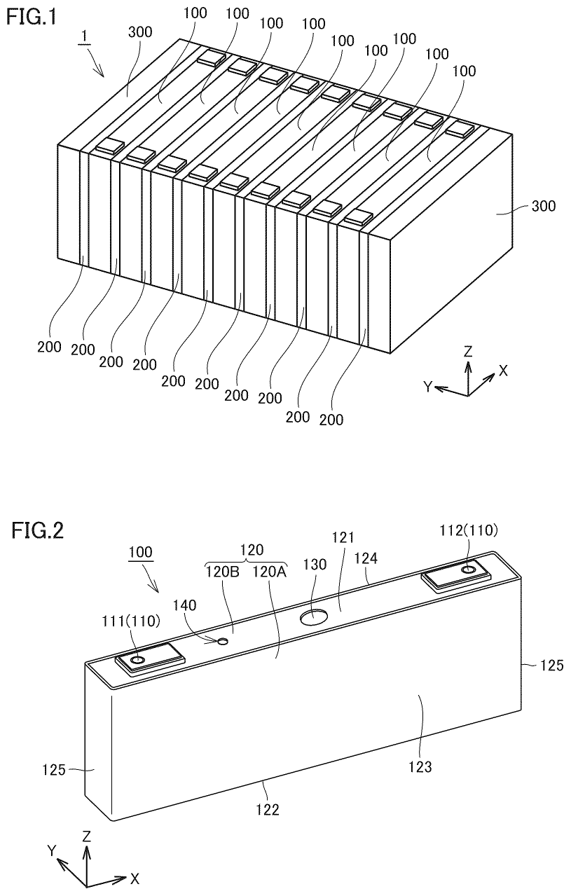

FIG. 2 is a perspective view showing each battery 100. As shown in FIG. 2, battery 100 has a prismatic shape. Battery 100 has electrode terminals 110, a housing 120, a gas-discharge valve 130, and an injection hole 140.

Electrode terminals 110 are formed on housing 120. Electrode terminals 110 have a positive electrode terminal 111 and a negative electrode terminal 112 arranged side by side along an X axis direction (second direction) orthogonal to the Y axis direction. Positive electrode terminal 111 and negative electrode terminal 112 are provided to be separated from each other in the X axis direction.

Housing 120 has a rectangular parallelepiped shape and forms an external appearance of battery 100. Housing 120 includes: a case main body 120A that accommodates an electrode assembly and an electrolyte solution; and a sealing plate 120B that seals an opening of case main body 120A. Sealing plate 120B is joined to case main body 120A by welding.

Housing 120 has an upper surface 121, a lower surface 122, a first side surface 123, a second side surface 124, and two third side surfaces 125. Each of upper surface 121, lower surface 122, first side surface 123, second side surface 124 and third side surfaces 125 has a rectangular shape.

Upper surface 121 is a flat surface orthogonal to a Z axis direction (third direction) orthogonal to the Y axis direction and the X axis direction. Electrode terminals 110 are disposed on upper surface 121. Lower surface 122 faces upper surface 121 along the Z axis direction.

Each of first side surface 123 and second side surface 124 is constituted of a flat surface orthogonal to the Y axis direction. Each of first side surface 123 and second side surface 124 has the largest area among the areas of the plurality of side surfaces of housing 120. Each of first side surface 123 and second side surface 124 has a rectangular shape when viewed in the Y axis direction. Each of first side surface 123 and second side surface 124 has a rectangular shape in which the X axis direction corresponds to the long-side direction and the Z axis direction corresponds to the short-side direction when viewed in the Y axis direction.

The plurality of batteries 100 are stacked such that first side surfaces 123 of batteries 100, 100 adjacent to each other in the Y direction face each other and second side surfaces 124 of batteries 100, 100 adjacent to each other in the Y axis direction face each other. Thus, positive electrode terminals 111 and negative electrode terminals 112 are alternately arranged in the Y axis direction in which the plurality of batteries 100 are stacked.

Each of case main body 120A and sealing plate 120B is composed of a metal. Specifically, each of case main body 120A and sealing plate 120B is composed of aluminum, an aluminum alloy, iron, an iron alloy, or the like.

Case main body 120A is formed to be longer in the width direction (X axis direction) of battery 100 than in each of the thickness direction (Y axis direction) and the height direction (Z axis direction) of battery 100. That is, when battery 100 is viewed in the Y axis direction, housing 120 (case) of battery 100 has a substantially rectangular shape in which the X axis direction (second direction) corresponds to the long-side direction and the Z axis direction (third direction) corresponds to the short-side direction.

Gas-discharge valve 130 is provided in upper surface 121. When the temperature of battery 100 is increased (thermal runaway) and internal pressure of housing 120 becomes more than or equal to a predetermined value due to gas generated inside housing 120, gas-discharge valve 130 discharges the gas to outside of housing 120.

Injection hole 140 is provided in upper surface 121. The electrolyte solution is injected into housing 120 through injection hole 140. Injection hole 140 is sealed by a sealing member. As the sealing member, for example, a blind rivet or another metal member can be used.

The positions of gas-discharge valve 130 and injection hole 140 are not limited to those shown in FIG. 2, and can be appropriately changed.

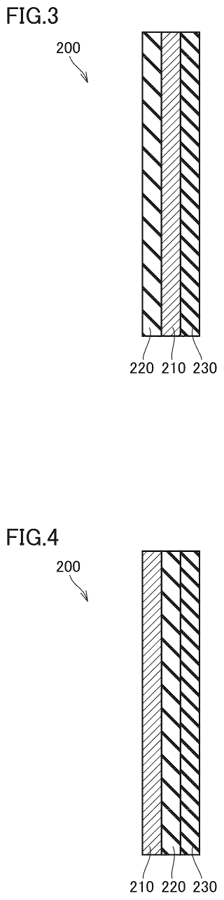

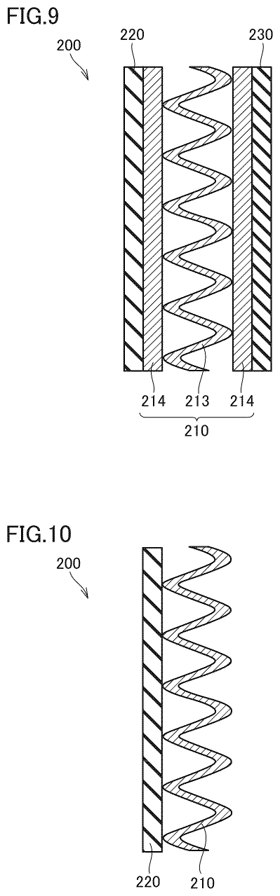

Next, the structure of separator 200 will be described with reference to FIGS. 3 to 10. Each of FIGS. 3 to 10 is a cross sectional view of separator 200 when viewed in the X axis direction.

In the example shown in FIG. 3, separator 200 includes a first layer 210, a second layer 220, and a third layer 230. First layer 210, second layer 220, and third layer 230 are provided side by side in the Y axis direction. First layer 210 is disposed to be sandwiched between second layer 220 and third layer 230.

The melting point of first layer 210 is about 950° C. or more (preferably about 1000° C. or more, and more preferably about 1200° C. or more). Moreover, the melting point of first layer 210 is preferably about 2715° C. or less, and more preferably about 2000° C. or less. First layer 210 is preferably composed of a metal, a ceramic, or glass.

Examples of the metal having the melting point of about 950° C. or more include gold (1064° C.), silver (962° C.), titanium (1668° C.), copper (1085° C.), nickel (1455° C.), stainless steel (about 1400 to 1500° C.), and the like.

Examples of the ceramic having the melting point of 950° C. or more include alumina (about 2050° C. to 2070° C.), zirconia (2715° C.), and the like. Examples of the glass having the melting point of 950° C. or more include magnesium fluoride glass (1255° C.).

For example, when housing 120 of battery 100 is composed of aluminum, the melting point (950° C. or more) of first layer 210 is higher than the melting point of housing 120 because the melting point of aluminum is about 660° C. Moreover, the thickness of first layer 210 is preferably about 0.3 mm or more and 2.0 mm or less.

Second layer 220 has a heat conductivity of about 0.02 W/m· K or more and 0.15 W/m·K or less under a high-temperature and high-pressure environment of a temperature of 700° C. and a pressure of 0.2 MPa. Second layer 220 can be composed of, for example, nanosilica, glass fiber, nonwoven fabric, or the like. The thickness of second layer 220 is preferably about 3 mm or less.

Third layer 230 has a function of absorbing increased reaction force from battery 100 when battery 100 is expanded. A test piece having a rectangular shape and a dimension of 50 mm square when the material of third layer 230 is viewed in the Y axis direction is cut out, and a compressive load is applied to the test piece. On this occasion, the thickness of the test piece and the compressive load acting on the test piece are simultaneously measured. According to the above measurement results, the compression load is preferably about 0.7 kN or more when the thickness of the test piece is 5 mm, and the compression load is preferably 8 kN or less when the thickness of the test piece is 2.5 mm. Third layer 230 can be composed of, for example, an elastic body such as rubber (EPDM), silicone, foamed rubber, or foamed silicone.

When thermal runaway occurs in a battery 100 included in battery assembly 1, it is required to suppress an unintended influence on an adjacent battery 100. This point is evaluated in a performance test for battery pack.

For example, in an evaluation test for a battery pack including battery assembly 1, a specific battery 100 (trigger cell) in battery assembly 1 may forcibly undergo thermal runaway so as to evaluate a subsequent behavior of the battery pack as a whole (for example, whether or not spreading fire can be prevented). Specifically, the trigger cell is subjected to forcible short-circuit by nail penetration, heating with a heater, or the like.

Examples of standards of the above-described evaluation test include those defined in UN Regulations “UN ECE-R100”, “National Standards of the People's Republic of China (GB)” of China, “JIS C 8715” of Japanese Industrial Standards, and the like.

Since first layer 210 having the melting point of about 950° C. or more and 2715° C. or less is provided in separator 200 according to the present embodiment, even when thermal runaway occurs in one battery 100 included in battery assembly 1, melting of first layer 210 provided between adjacent batteries 100 can be suppressed or retarded. Therefore, battery 100 adjacent to battery 100 having undergone the thermal runaway can be protected. First layer 210 has a function as a heat-resistant layer when thermal runaway occurs.

Since second layer 220 having a heat conductivity of about 0.02 W/m· K or more and 0.15 W/m·K or less (under an environment of a temperature of 700° C. and a pressure of 0.2 MPa) is provided in separator 200 according to the present embodiment, it is possible to ensure heat insulation between adjacent batteries 100 in a region of temperature with which thermal runaway does not occur. Moreover, when second layer 220 has the same melting point as that of first layer 210, second layer 220 also can exhibit a function in cooperation with first layer 210 during thermal runaway so as to protect battery 100 adjacent to battery 100 having undergone thermal runaway.

In separator 200 according to the present embodiment, third layer 230 composed of the elastic body having a predetermined deformation absorption property is provided, with the result that increased reaction force from battery 100 can be absorbed even when housing 120 is expanded during use of battery 100. Therefore, since such a mechanism for absorbing the reaction force can be incorporated in separator 200, it is possible to achieve space saving in the Y axis direction and size reduction of battery assembly 1 as a whole.

Thus, according to separator 200 of the present embodiment, first layer 210, second layer 220, and third layer 230 are in cooperation with one another, thereby achieving heat insulation between batteries 100, suppression of an unintended influence on adjacent batteries 100 at the time of thermal runaway, and size reduction of battery assembly 1 as a whole.

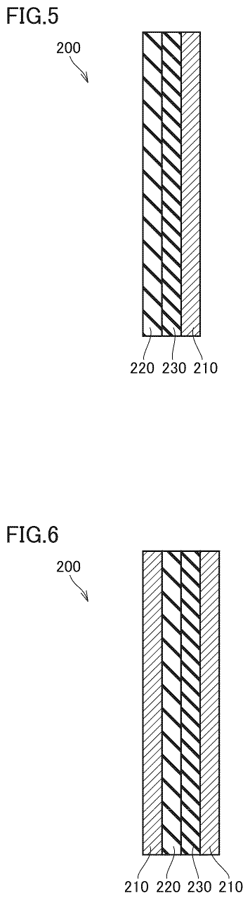

In the example of FIG. 3, first layer 210 is disposed to be sandwiched between second layer 220 and third layer 230, but the scope of the present technology is not limited thereto, and second layer 220 may be disposed to be sandwiched between first layer 210 and third layer 230 as shown in FIG. 4, or third layer 230 may be disposed to be sandwiched between first layer 210 and second layer 220 as shown in FIG. 5, for example. Further, as shown in FIG. 6, second layer 220 and third layer 230 may be disposed to be sandwiched between two first layers 210.

When first layer 210 is disposed at a position in abutment with battery 100 as in each of the examples of FIGS. 4 to 6, at least a surface of first layer 210 is configured to have an insulating property.

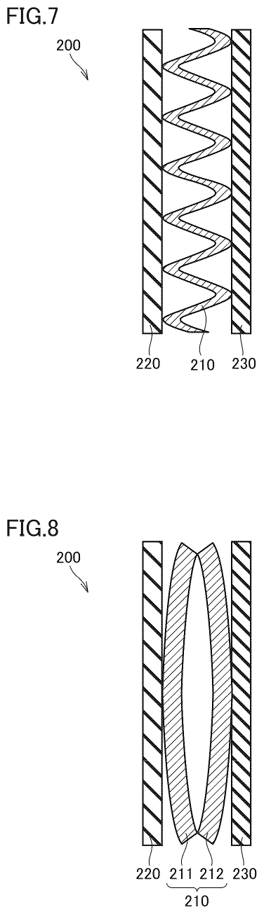

A feature in each of the examples of FIGS. 7 to 10 lies in that first layer 210 includes a portion having a wave shape (FIGS. 7, 9, and 10) or a curved shape (FIG. 8). It should be noted that the waveform shape and the curved shape are not limited to those shown in FIGS. 7 to 10.

According to the examples of FIGS. 7 to 10, increased reaction force from battery 100 can be absorbed by elastically deforming the waveform portion or curved portion of first layer 210. As in each of the examples of FIGS. 7 to 9, the waveform portion or curved portion and third layer 230 may be used together, or when the above-described function of third layer 230 can be replaced by providing the waveform portion (or curved portion) in first layer 210, separator 200 may be constituted only of first layer 210 and second layer 220 as in the example of FIG. 10.

In the present embodiment, gas-discharge valve 130, injection hole 140, and electrode terminals 110 are disposed at the same surface of housing 120, but the scope of the present technology is not limited thereto, and gas-discharge valve 130, injection hole 140, and electrode terminals 110 may be disposed at different surfaces of housing 120. Moreover, electrode terminals 110 may be disposed on a surface other than upper surface 121, and positive electrode terminal 111 and negative electrode terminal 112 may be disposed on different surfaces of housing 120.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A battery assembly comprising:
a plurality of batteries arranged in a first direction; and
a separator provided between the plurality of batteries, wherein
the separator includes
a first layer having a melting point of 950° C. or more and 2715° C. or less,
a second layer having a heat conductivity of 0.02 W/m·K or more and 0.15 W/m·K or less under an environment of a temperature of 700° C. and a pressure of 0.2 MPa, and
a third layer for which a compressive load acting on a test piece having a rectangular shape and a dimension of 50 mm square when viewed in the first direction is 0.7 kN or more when a thickness of the test piece is 5 mm and is 8 kN or less when the thickness of the test piece is 2.5 mm, and
the first layer, the second layer, and the third layer are provided side by side in the first direction.

2. The battery assembly according to claim 1, wherein the first layer includes a portion having a waveform shape or a curved shape.

3. The battery assembly according to claim 1, wherein the first layer is disposed to be sandwiched between the second layer and the third layer in the first direction.

4. The battery assembly according to claim 1, wherein
the first layer includes a portion having a waveform shape or a curved shape, and
the first layer is disposed to be sandwiched between the second layer and the third layer in the first direction.

5. The battery assembly according to claim 1, wherein the first layer is composed of a metal, a ceramic, or glass.

6. The battery assembly according to claim 1, wherein
the first layer includes a portion having a waveform shape or a curved shape,
the first layer is disposed to be sandwiched between the second layer and the third layer in the first direction, and
the first layer is composed of a metal, a ceramic, or glass.

7. The battery assembly according to claim 1, wherein the first layer has a thickness of 0.3 mm or more and 2.0 mm or less.

8. The battery assembly according to claim 1, wherein
the first layer includes a portion having a waveform shape or a curved shape,
the first layer is disposed to be sandwiched between the second layer and the third layer in the first direction,
the first layer is composed of a metal, a ceramic, or glass, and
the first layer has a thickness of 0.3 mm or more and 2.0 mm or less.

9. A battery assembly comprising:
a plurality of batteries arranged in a first direction; and
a separator provided between the plurality of batteries, wherein
the separator includes
a first layer having a melting point of 950° C. or more and 2000° C. or less, and
a second layer having a heat conductivity of 0.02 W/m·K or more and 0.15 W/m·K or less under an environment of a temperature of 700° C. and a pressure of 0.2 MPa,
the first layer includes a portion having a waveform shape or a curved shape, and
the first layer and the second layer are provided side by side in the first direction.

10. The battery assembly according to claim 9, wherein the first layer is composed of a metal, a ceramic, or glass.

11. The battery assembly according to claim 9, wherein the first layer has a thickness of 0.3 mm or more and 2.0 mm or less.

12. The battery assembly according to claim 9, wherein
the first layer is composed of a metal, a ceramic, or glass, and
the first layer has a thickness of 0.3 mm or more and 2.0 mm or less.
